(19) United States
(12) Patent Application Publication
(10) Pub. No.: US 2022/0076212 A1
(43) Pub. Date: Mar. 10, 2022

(54) METHODS FOR MANAGING REPAIR PROCEDURES FROM DISPARATE SOURCES

(71) Applicant: Mitchell International, Inc., San Diego, CA (US)

(72) Inventors: Mike Milliken, San Diego, CA (US); Scott Baierl, San Diego, CA (US); Jerry Gastineau, San Diego, CA (US); John Strong, San Diego, CA (US); Penny Genovese, San Diego, CA (US); Randy Susana, San Diego, CA (US); Sarika Gupta, San Diego, CA (US)

(73) Assignee: Mitchell International, Inc., San Diego, CA (US)

(21) Appl. No.: 17/015,013

(22) Filed: Sep. 8, 2020

(51) Int. Cl. G06Q 10/00; G06Q 10/10; G06F 16/93

(52) U.S. Cl. CPC G06Q 10/20; G06F 16/93; G06Q 10/10

(57) ABSTRACT

Systems and methods are provided for automating the process of cataloging repair documents published by Original Equipment Manufacturers (OEMs). The method determines a corresponding service repair vehicle for the OEM vehicle associated with eh repair documents. Further, the OEM repair instructions are associated with the one or more vehicle parts of a service repair vehicle identified in a repair estimate record. The method of cataloging repair procedures from various OEMs utilizes standardized naming conventions a database structure for uploading individual documents.

### TECHNICAL FIELD

The present disclosure is generally related to systems and methods for managing repair procedure documents from a variety of providers, and more particularly, some embodiments relate to a systems and methods for implementing the same.

### SUMMARY

In accordance with one or more embodiments, various features and functionality can be provided for managing repair procedure documents from a variety of providers.

In some embodiments, a method may receive a set of OEM repair documents. Each OEM repair document may specify OEM repair instructions generated by an OEM for repairing an OEM vehicle.

In some embodiments, the method may determine a service repair vehicle corresponding to the OEM vehicle.

In some embodiments, the method may associate the OEM repair instructions specified by the set of OEM repair documents with one or more parts of the service repair vehicle. In some embodiments, the one or more parts of the service vehicle are identified in a repair estimate record identified based on the service vehicle. In some embodiments, the method may utilize a database structure for uploading individual documents. By uploading repair documents to a database with a particular data structure results in a more efficient subsequent use of repair documents.

In some embodiments, the method may associate repair document provider, document type, navigation path specified by each OEM repair document of the set of OEM repair documents with the service repair vehicle by recording the association in the data repository.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 illustrates an example repair document management system, according to an implementation of the disclosure.

FIG. 2 illustrates processes for updating repair document repository, according to an implementation of the disclosure.

FIGS. 3A-3C illustrate example data structures utilized for storing repair documents from disparate sources, according to an implementation of the disclosure.

FIGS. 4A-4B illustrate example components of a repair document management process, according to an implementation of the disclosure.

FIGS. 5A-5D illustrate an example graphical user interface of a collision repair estimating tool, according to an implementation of the disclosure.

FIG. 6 illustrates an example computing system that may be used in implementing various features of embodiments of the disclosed technology.

### DETAILED DESCRIPTION

Described herein are systems and methods for managing repair documents published by Original Equipment Manufacturers (OEMs). The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

OEMs generate repair manuals which include technical information used to service and maintain a vehicle (e.g., repair instructions, diagnostic information, diagramed repair and replacement procedures, electrical diagrams and training information) specific to Year, Make, Model and Engine (YMME). In addition to providing detailed repair instructions that ensure accurate and compliant vehicle repair, these OEM repair documents often call for specific parts or tools by using an OEM part number, simplifying the ordering process. For example, during a repair of a left front fender in a GM vehicle, the repair technician may be referencing a particular set of documents for that specific vehicle.

Individual OEMs publish repair manuals in a variety of formats. Each manual for specific YMME may comprise thousands individual repair documents. However, most OEMs generally utilize some type of data standardization and naming convention protocols across all its manufactured vehicles. For example, repair documents published by a particular OEM may include identifying data, e.g., document title, resulting in similarly named documents for a particular part. While the contents of the documents may vary based on YMME, the type(s) of repair documents may be the same.

Undoubtedly, referencing OEM repair documents during the collision repair process ensures the highest level of quality and safety. Yet, identifying which particular OEM document should be used for a specific vehicle, part, and/or labor operation, for example as identified in a repair estimate or repair order line item entry, has been a challenge. Especially, when taking into consideration the considerable substantial time and skill required to locate each particular repair document. Because of the sheer volume of repair procedure documents, greatly varying in format even across the same OEM, uploading repair documents to a uniform data structure may be challenging.

Embodiments of the disclosed technology provide a system and method for cataloging repair documents from a variety of OEMs in a uniform data structure. In particular, by virtue of cataloging repair documents from disparate sources allows the system to homogenize repair documents resulting in an improved method for determining associations between particular repair documents and particular repair collision repair estimate line information (e.g., vehicle, part, and/or labor operation line items). For example, the associations may be determined manually (e.g., by a user with specific knowledge of vehicles and vehicle repair processes) or automatically, as further disclosed in a co-pending application Ser. No. 16/944,038, filed Jul. 30, 2020, titled “SYSTEMS AND METHODS FOR AUTOMATING MAPPING OF REPAIR PROCEDURES TO REPAIR INFORMATION,” incorporated by reference herein.

This uniform cataloging of repair documents (prior to generating associations) provides several advantages. First, the cataloging of repair documents ensures that each individual document provided by each OEM is identified within the system using uniform rules. That is, by applying the same rules for storing each document, ensures consistency between individual users who will subsequently use the repair documents. Specifically, by applying uniform document cataloging rules allows the documents to be cross-referenced to one or more document source providers, repaired vehicles, OEM vehicles, OEM documents, document specification, and/or one or more items in a repair estimate document (e.g., vehicles panels or locations of damage/repair, one or more vehicle parts used in the vehicle, and/or one or more labor operations). Further, by virtue of utilizing data cataloging rules applied in a defined data structure environment when cataloging repair documents from disparate sources, ensures that each repair document can then be easily located when the document is being associated to a vehicle, part, and/or labor operations during the vehicle repair estimating process, as alluded to above. Similarly, the cataloging process ensures that documents can be easily located by the repair technician for viewing and printing. Finally, using uniform data cataloging rules for uploading repair documents to a defined data structure, allows the cataloging process to be performed either manually (i.e., by a user) or via an automated cataloging process.

### System

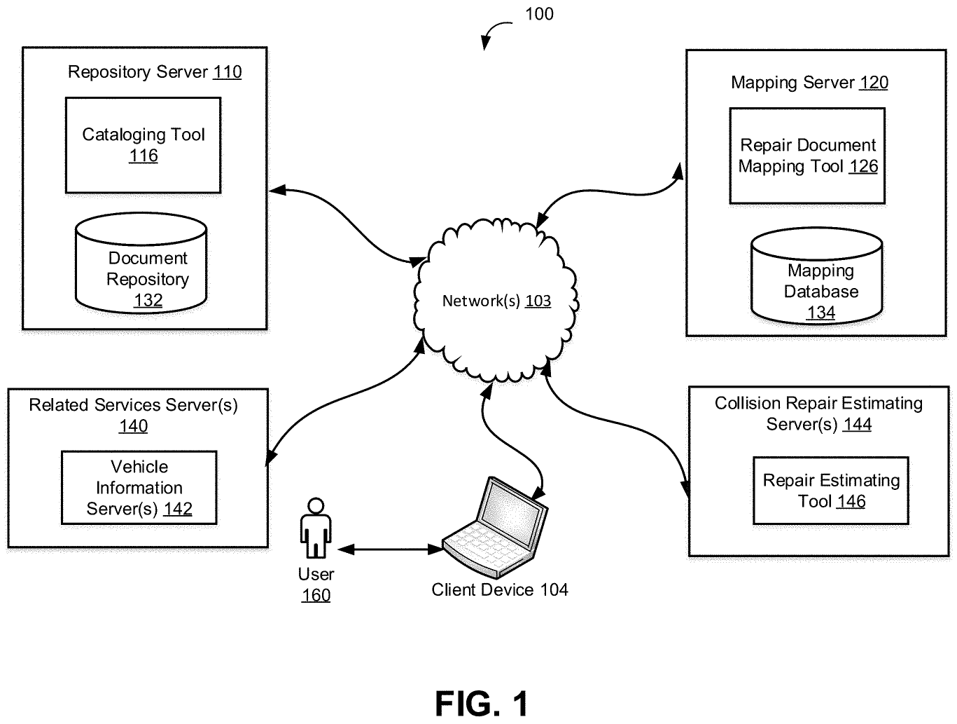

FIG. 1 illustrates an automated repair document repository system 100 according to some embodiments of the disclosed technology. In some embodiments, system 100 may include a repository server 110, a mapping server 120, a one or more related services server(s) 140 (e.g., vehicle information server(s) 142), a collision repair estimating server(s) 144, and other such similar servers), a network 103, and a client computing device 104. A user 160 may be associated with client computing device 104 as described in detail below. Additionally, system 100 may include other network devices such as one or more routers and/or switches.

In some embodiments, client computing device 104 may include a variety of electronic computing devices, for example, a smartphone, a tablet, a laptop, a display, a mobile phone, a computer wearable device, such as smart glasses, or any other head mounted display device, or a combination of any two or more of these data processing devices, and/or other devices.

### Repository Server

In some embodiments, repository server 110 may transmit and receive information to and from client computing device 104, one or more vehicle information servers 142, one or more collision repair estimating server, and/or other servers via network 103. For example, a communication interface of the repository server 110 may be configured to operatively couple and communicate between document repository 132, client computing device 104, mapping server 120, vehicle information servers 142, and collision repair estimating server 144, which are all coupled together by the communication network(s) 103.

In some embodiments, repair cataloging tool 116 may access document repository 132 and mapping databases 134 over a network 130 such as the Internet, via direct links, and the like.

In some embodiments, repository server 110 may be a standalone device or integrated with one or more other devices or apparatuses, such as one or more of the storage devices, for example. For example, repository server 110 may include or be hosted by one of the storage devices, and other arrangements are also possible.

For example, repository server 110 may include cataloging tool 116. In some embodiments, cataloging tool 116, which may be implemented as one or more software packages executing on one or more repository server 110 computers. For example, a client application implemented on one or more client computing device 104 as client mapping tool application. In some embodiments, cataloging tool 116 may be a server application, a server module of a client-server application, or a distributed application. In some embodiments, cataloging tool 116 may be implemented using a combination of hardware and software. The application(s) can be implemented as modules, engines, or components of other application(s). Further, the application(s) can be implemented as operating system extensions, module, plugins, or the like.

### Mapping Server

In some embodiments, mapping server 120 may transmit and receive information to and from client computing device 104, one or more repository server 110, vehicle information server 142, repair estimating server 144, and/or other servers via network 103. For example, a communication interface of the mapping server 120 may be configured to operatively couple and communicate between document repository 132, mapping database 134, client computing device 104, repository server 110, vehicle information servers 140, repair estimating server 144, which are all coupled together by the communication network(s) 103.

In some embodiments, repair document mapping tool 126 may access document repository 132 and mapping databases 134 over a network 130 such as the Internet, via direct links, and the like. In some embodiments, mapping server 120 may be a standalone device or integrated with one or more other devices or apparatuses, such as one or more of the storage devices, for example. For example, mapping server 120 may include or be hosted by one of the storage devices, and other arrangements are also possible.

For example, mapping server 120 may include repair document mapping tool 126. In some embodiments, repair document mapping tool 126, which may be implemented as one or more software packages executing on one or more mapping server 120 computers. For example, a client application implemented on one or more client computing device 104 as client mapping tool application. In some embodiments, repair document mapping tool 126 may be a server application, a server module of a client-server application, or a distributed application. In some embodiments, repair document mapping tool 126 may be implemented using a combination of hardware and software. The application(s) can be implemented as modules, engines, or components of other application(s). Further, the application(s) can be implemented as operating system extensions, module, plugins, or the like.

### Related Services Server

In some embodiments, related services server 140 may include vehicle information server 142 configured to store and/or manage vehicle information associated with a damaged vehicle. For example, vehicle information may include vehicle identification information, such as vehicle identification number (VIN), make, model, and optional modifications (e.g., sub-model and trim level), date and place of manufacture, and similar information related to a damaged vehicle. Additionally, related services server 140 may include repair estimate server 144 configured to store, manage, and process information related completed estimates, estimates in process, configured to store data related to repair estimate data maintained by the collision repair entity or the automotive. In some embodiments, repair estimate server 144 may be configured to communicate with third-party services (e.g., automotive insurance carriers) to request and receive data regarding parts, part costs, labor, labor costs, and such similar data related to a particular repair event.

In some embodiments, each of repository server 110, mapping server, 120, related services server 140, vehicle information server 142, and collision repair estimating server 144 may include any type of computing device that can be used to interface with repository server 110 and/or cataloging tool 116, document repository 132, repository server 120, repair document mapping tool 126, mapping databases 134, vehicle information servers 140, and collision repair estimating servers 144, and client computing device tool 104. For example, each of mapping server, 120, related services server 140, vehicle information server 142, and collision repair estimating server 144 may include a processor, a memory, and a communication interface, which are coupled together by a bus or other communication link, although other numbers and/or types of network devices could be used. In some embodiments, each of related services server 140, vehicle information server 142, and collision repair estimating server 144 may also include a database.

### System Architecture

In some embodiments, repository server 110, mapping server, 120, related services server 140, vehicle information server 142, and collision repair estimating server 144, and or other components may be a single device. Alternatively, a plurality of devices may be used. For example, the plurality of devices associated with related services server 140, vehicle information server 142, and repair estimate server 144 may be distributed across one or more distinct network computing devices that together comprise one or more related services server 140, vehicle information server 142, and repair estimate server 144.

In some embodiments, repository server 110, mapping server, 120, related services server 140, vehicle information server 142, and collision repair estimating server 144 may not be limited to a particular configuration. Thus, in some embodiments, repository server 110, mapping server, 120, related services server 140, vehicle information server 142, and collision repair estimating server 144 may contain a plurality of network devices that operate using a master/slave approach, whereby one of the network devices operate to manage and/or otherwise coordinate operations of the other network devices. Additionally, in some embodiments, repository server 110, mapping server, 120, related services server 140, vehicle information server 142, and collision repair estimating server 144 may comprise different types of data at different locations.

In some embodiments, repository server 110, mapping server, 120, related services server 140, vehicle information server 142, and collision repair estimating server 144 may operate as a plurality of network devices within a cluster architecture, a peer-to-peer architecture, virtual machines, or within a cloud architecture, for example. Thus, the technology disclosed herein is not to be construed as being limited to a single environment and other configurations and architectures are also envisaged.

Although the exemplary network environment 100 with client computing device 104, repository server 110, mapping server, 120, related services server 140, vehicle information server 142, and collision repair estimating server 144, and network(s) 103 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as client computing device 104, repository server 110, mapping server, 120, related services server 140, vehicle information server 142, and collision repair estimating server 144 may be configured to operate as virtual instances on the same physical machine. In other words, one or more of client computing device 104, repository server 110, mapping server, 120, related services server 140, vehicle information server 142, and collision repair estimating server 144 may operate on the same physical device rather than as separate devices communicating through communication network(s). Additionally, there may be more or fewer devices than client computing device 104, repository server 110, mapping server, 120, related services server 140, vehicle information server 142, and collision repair estimating server 144.

In addition, two or more computing systems or devices can be substituted for any one of the systems or devices, in any example set forth herein. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including, by way of example, wireless networks, cellular networks, PDNs, the Internet, intranets, and combinations thereof.

Even further, the application(s) may be operative locally on the device or in a cloud-based computing environment. The application(s) can be executed within or as virtual machine(s) or virtual server(s) that may be managed in a cloud-based computing environment. Also, the application(s), and even the repair management computing device itself, may be located in virtual server(s) running in a cloud-based computing environment rather than being tied to one or more specific physical network computing devices. Also, the application(s) may be running in one or more virtual machines (VMs) executing on the repair management computing device.

### Repair Document Management Process Overview

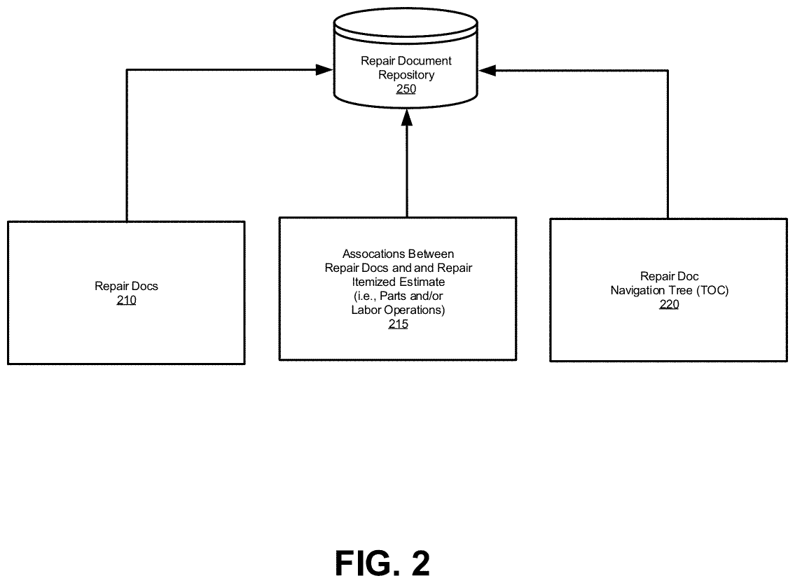

FIG. 2 illustrates data that may be uploaded to a repair document repository (e.g., document repository 132 illustrated in FIG. 1), according to an implementation of the disclosure. The data may include repair documents or publications 210, associations between repair documents and repair itemized estimate 215, and repair document navigation tree 220.

For example, repair publications obtained from various repair publication providers may be uploaded and cataloged by a repair document cataloging tool (e.g., repair document cataloging tool 116, illustrated in FIG. 1) within the repair document repository, at 210. As alluded to above, repair publications may include repair instructions, diagnostic information, diagramed repair and replacement procedures, electrical diagrams and training information specific to Year, Make, Model and Engine (YMME) used by repair technicians when repairing a vehicle (e.g., after a collision incident) may be generated by a variety of OEMs in a variety of file formats. Each OEM may utilize unique file naming conventions for naming documents that are used to repair the same or similar parts. Furthermore, each OEM may organize repair procedure documents within their manual in a different manner. As alluded to earlier, by utilizing a uniform data structure for cataloging repair documents form a plurality of OEMs ensures that individual documents from particular OEMs are located faster.

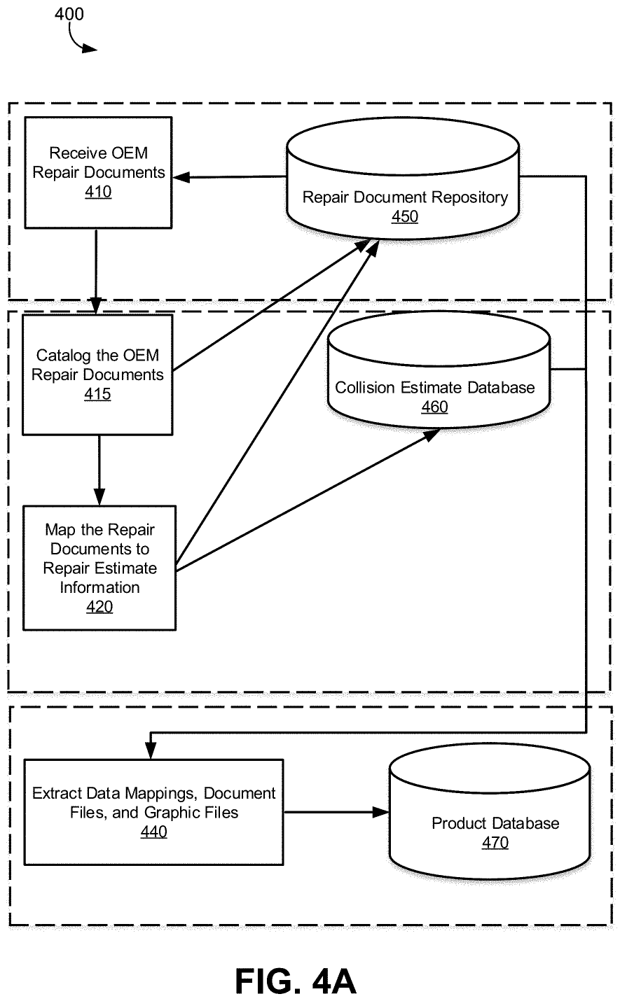

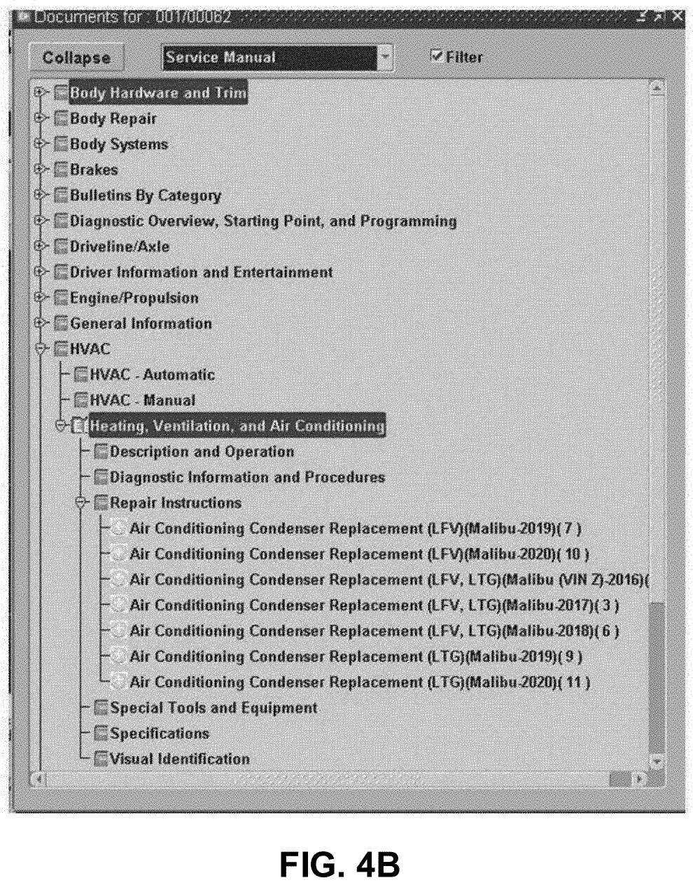

In some embodiments, the OEM documents may be cataloged via an automated process and significantly reduce labor costs and minimize user errors, as further described in reference to FIG. 4. In other embodiments, OEM repair documents may be cataloged manually, e.g., by a specially trained user or a user with specific knowledge, such as a Vehicle Collision Specialist. However, manual cataloging is expensive and requires precise knowledge of each OEM and their formatting structures. Additionally, users manually cataloging OEM repair documents must ensure they are familiar with any changes an OEM may implement from time to time.

In some embodiments, repair cataloging tool 116 may utilize a database structure for uploading individual documents. By uploading repair documents to a database with a particular data structure allows the repair documents to be utilized more efficiently during future operations.

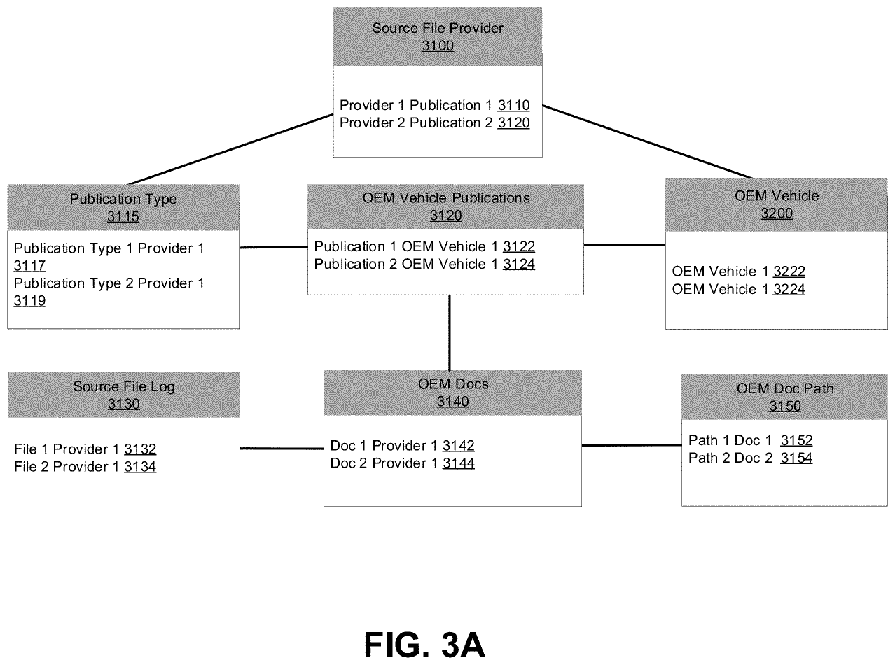

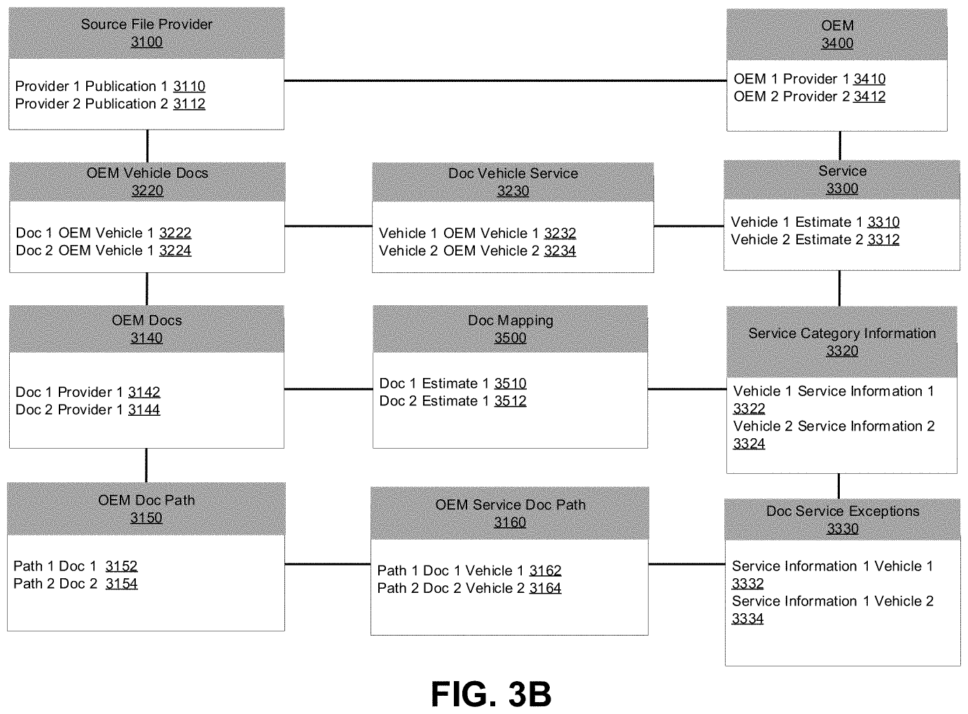

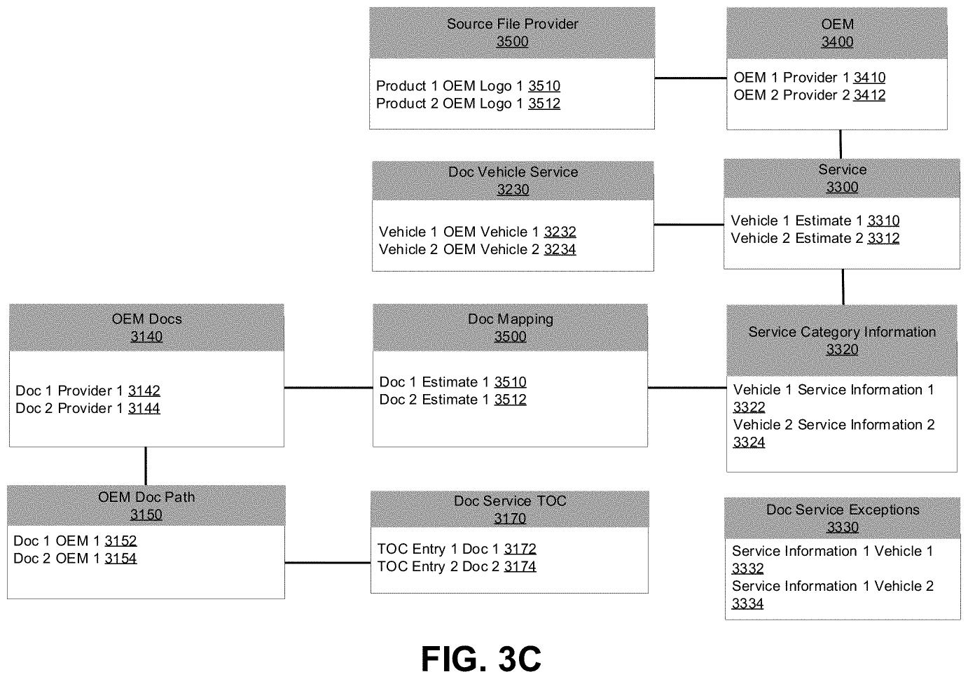

In some embodiments, data associated with repair documents may be parsed based on a plurality of data rules and uploaded to individual tables within repair document repository 250. For example, as illustrated in FIG. 3A, provider information associated with individual publications 1, 2 may be uploaded to a Source File Provider table 3100 as entries 3100, 3120. Next, publication type associated with each publication 1, 2, provided by each provider may be uploaded to a Publication Type table 3115 as entries 3117, 3119. Individual publications 1, 2 associated with each OEM vehicle may be uploaded to OEM Vehicle Publication table 3120 as entries 3122, 3124. OEM Vehicle table 3200 may be prepopulated with data related to OEM Vehicle as entries 3222, 3224. Individual documents 1, 2 included in each publication associated with each OEM vehicle may be uploaded to OEM Docs table 3140 as entries 3142, 3144. Additionally, individual navigation paths 1, 2 that a user (e.g., repair technician) may need to use to access individual documents 1, 2 on the OEM's website may be uploaded to OEM Doc Path table 3150 as entries 3152, 3154. Finally, a log of source files 1, 2 from each provider 1, 2 processed by the repair cataloging tool 116 may uploaded to OEM Source File Log table 3130 as entries 3132, 3134.

Referring back to FIG. 2, associations between individual repair documents and an itemized repair estimate document which provides information related to parts and/or labor operations may be recorded within repair document repository 250, at 215. The associations may be generated manually or automatically, as will be further described herein. In some embodiments, associations between repair documents and repair estimate line items may be stored in accordance with one or more data rules and in individual tables of repair document repository 250.

For example, as illustrated in FIG. 3B, association between Repair Service Vehicle 1, 2 and OEM vehicle 1, 2 may be recorded in a Doc Vehicle Service table 3230 as entries 3232, 3234. This would be achieved by utilizing data stored in Source File Provider 3100, OEM 3400, OEM Vehicle 3200, OEM Vehicle Docs 3220 and Repair Service Vehicle 3300 tables. Next, the associations between the OEM's Repair Procedure documents for a given vehicle and specific estimate categories and/or line items are identified and recorded in a Doc Mapping table 3500 as entries 3510, 3520. OEM table 3400 may be prepopulated with data identifying OEMs 1, 2 and their associated document providers 1,2 as entries 3410, 3412. The vehicle 1,2 that may be used within a repair estimate for a given OEM may be prepopulated in a Repair Service Vehicle table 3300 as entries 3310, 3312. The associations between repair vehicle 1, 2 and individual data elements of repair estimate documents 1, 2 representing, e.g., parts, labor times, and labor operations, may be recorded in a Service Category Information table 3320 as entries 3322, 3324. Additionally, it should be noted that a document can be associated to one or more line items within a repair service vehicle and/or within multiple repair service vehicles. Finally, individual navigation paths 1, 2 that a user (e.g., repair technician) may need to use to access individual documents 1, 2 for a repaired vehicle 1, 2, on the OEM's website may be uploaded to OEM Doc Path table 3140 as entries 3142, 3144.

During this process, there can be incidents where mapping is unattainable and/or requires further research. These incidents may be identified in an existing table via a column that represents an exception or research flag. Alternatively, the exception may be recorded in a Doc Management Exception table 3330 as entries 3332, 3334, etc. For example, exceptions may include OEM vehicles that cannot or have not been associated to a repair service vehicle. Similarly, exceptions may include documents which are not collision repair related, or those that have include erroneous navigation paths or missing link information, and/or other such scenarios.

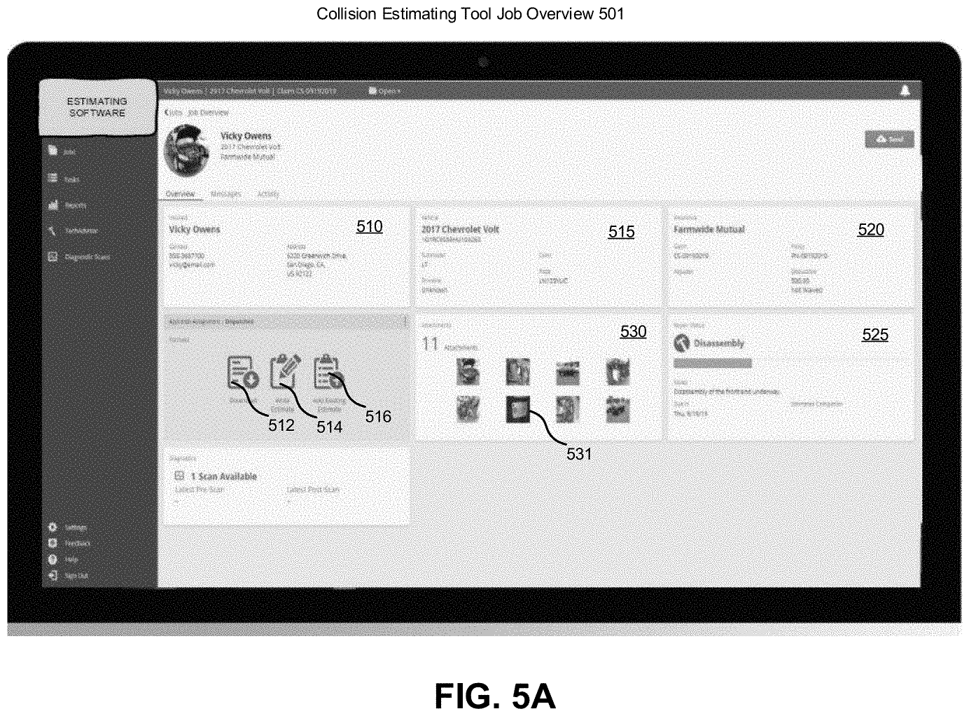

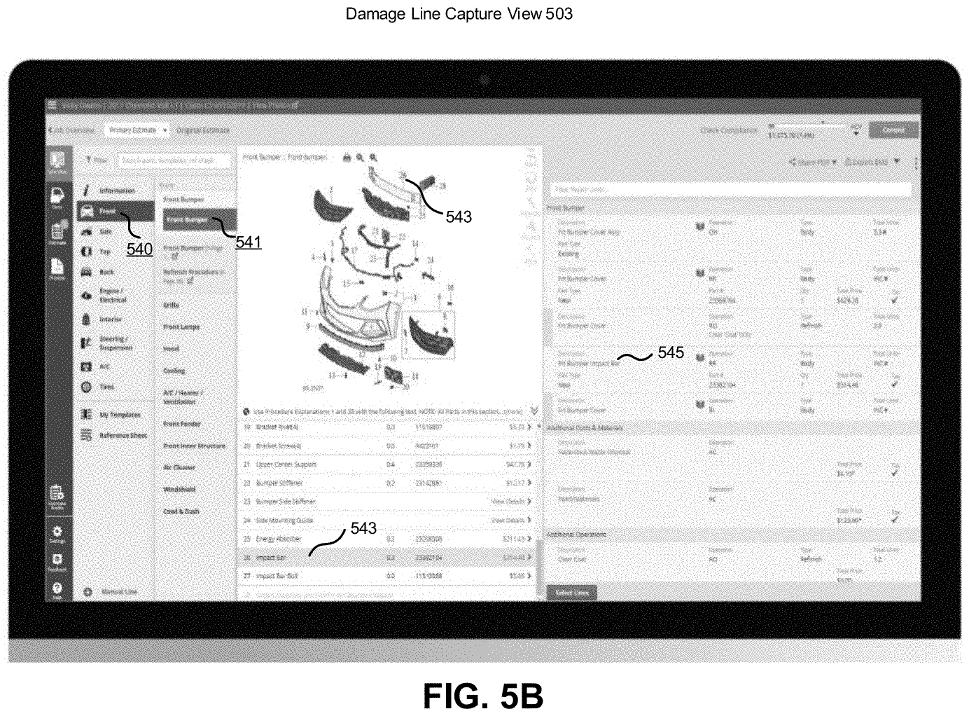

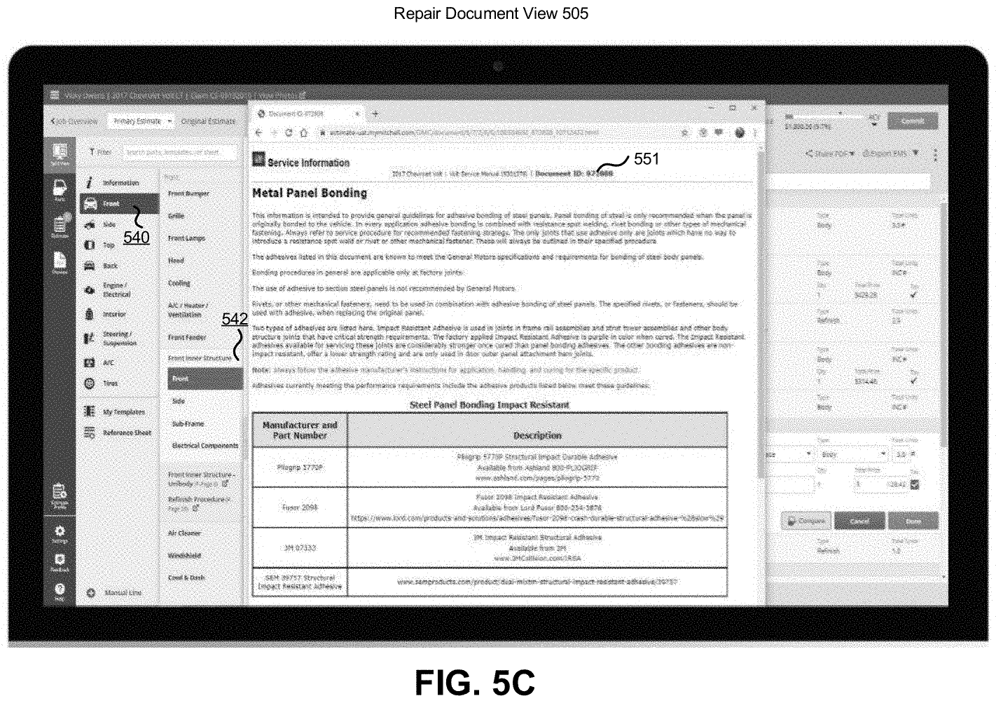

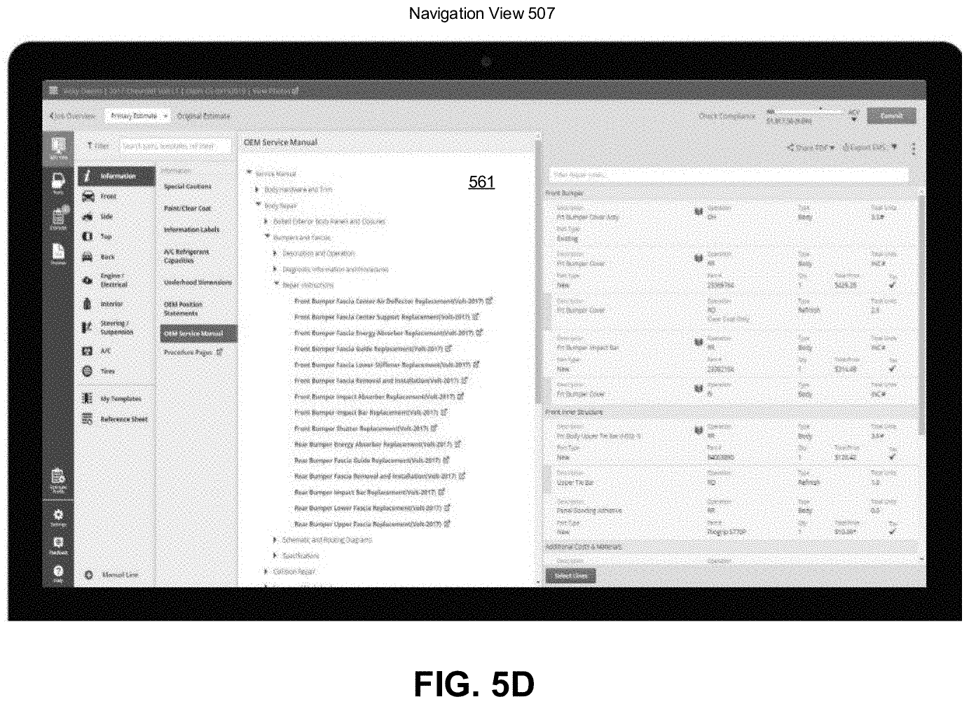

Referring back to FIG. 2, information used to generate a navigation tree or table of contents, utilized by a user for viewing repair procedures within a collision repair estimating tool (e.g., repair estimating tool 146 illustrated in FIG. 1), may be may be recorded within repair document repository 250, at 220. For example, as illustrated in FIG. 3C, table of content positions 1, 2, associated with documents 1, 2, may be uploaded to a Doc Service TOC table 3170 as entries 3172, 3174. The navigation tree may be generated data by repair estimating tool 146 by using the table of content position, as described in FIGS. 5A-5D, in further detail below.

### Components of Repair Management and Utilization Process

FIG. 4A illustrates example components of a repair document management process, according to an implementation of the disclosure. As illustrated in FIG. 4A, a process 400 may begin at 410 by receiving OEM repair documents from document repository 450. Next, at 415, OEM repair documents may be cataloged and uploaded back into document repository 450, as described in FIGS. 2 and 3A.

During the repair document management process, OEM documents may be cataloged and uploaded back to repository 450 via an automated process. The automated process may comprise one or more executable programs and/or database procedures that may be driven by values stored in the Repair Document Repository database 450. In some embodiments, the executable programs and/or database procedures may facilitate the process by using information related to the storage of repair procedure documents by OEM. For example, directories associated with repair procedure documents and other data used by OEM, directory structures, filename formats and/or naming standards used by OEM, information related to documents processed (both successfully and unsuccessfully), time stamp data (e.g., date the document was last processed).

The executable programs and/or database procedures may be executed periodically (e.g., at scheduled times), may be triggered based on receipt of an email from the OEM notifying of file delivery, upon user request, and/or in accordance with another rule. In some embodiments, the executable programs and/or database procedures may be executed upon satisfying a set of rules. For example, upon the OEM publishing new, may cause the executable programs and/or database procedures to be executed to identify new documents generated by the OEM that were not previously included in the data repository during the original upload process. Similarly, upon the OEM updating existing documents, may cause the executable programs and/or database procedures to be executed to identify updated documents generated by the OEM and execute the automated process to replace the updated documents. For example, the automated process may utilize filename formats and/or naming standards used by OEM to determine which documents are newly published by OEM and must be replaced. Because document file information is stored within the repository, the automated processes can compare the currently-delivered files to existing files within the repository (i.e., previously-delivered files by OEM). By comparing existing files to the new files associated with OEM documents, the automated process may determine which files are new and which files require an update. For example, OEM documents that do not have a corresponding filename are deemed as new, while documents that do have a corresponding filename are deemed as new as those that requiring update.

In some embodiments, the process 400 may identify information about the document such as the OEM (i.e., the entity that provides the document), the title of the repair document, the topic(s) described in the document, location of the document, and associated vehicle information. The process 400 may associate the OEM's vehicle identification information to a repair service vehicle identification information.

In some embodiments, for each OEM's vehicle make, model, and year range, process 400 may be configured to determine a corresponding repair service vehicle make, model, and year, and year range. For example, GM may identify a vehicle as “Oldsmobile Cutlass Ciera 1994”. The process 400 may determine that the corresponding repair service vehicle may be identified as “OLDSMOBILE CUTLASS SUPREME SEDAN (FWD) 1990-1997”.

In some embodiments, specificity, relevance, confidence and/or weight may be assigned to each OEM vehicle and corresponding repair service vehicle determination with respect to accuracy of the determination. For example, if a determination has a confidence score of 100%, then an associative link or a cross-reference may be generated and stored (e.g., in a document repository 450 or anther database). Alternatively, if the determination has a confidence score that is less than 100% but above a threshold amount (e.g., 80%), then a flag is generated for that OEM vehicle and stored (e.g., in a document repository 450 or anther database). Such OEM vehicles may be reviewed manually by a specially trained user and the automatically generated degermation may be accepted or rejected. Finally, if the process failed to produce any results or if the determination has a confidence score that falls below a threshold amount (e.g., 80%), then the OEM vehicle is deemed “rejected”. Rejected OEM vehicles may be reviewed manually by the automotive editor.

In some embodiments, the automated process may identify a table of contents associated to the publication containing the repair document. For example, by using information within the document or data provided by the OEM, the process 400 may determine a relative position of each document within the OEM publication (i.e., a relative position with respect to the hierarchy of positions associated with other documents within the publication). The relative position may be used to assist when navigating to the specific document within the OEM's publication and/or website. In some embodiments, a table of contents may include the following categories: type of publication, major category of repair (e.g., vehicle exterior), minor category of repair (e.g., front bumper), type of repair/procedure, and/or type of repair document that leads to one or more repair procedure article(s). For example, as illustrated in FIG. 4B, table of contents include “Service Manual” as type of publication, “Body Hardware and Trim” as major category of repair, “HVAC” as minor category of repair, “Heating, Ventilation, and Air Conditioning” as type of repair/procedure, and “Air Conditioning Condenser Replacement” one or more repair procedure article(s).

In some embodiments, the process may identify navigation path or link included in each repair document. These links may reference other documents, graphic images, and/or other file types within the manual (hyperlinks) or on provider's website (HTML links). In some embodiments, the identified links may be verified for accuracy. For example, file123.html contains references to fileabc.html and graphicxyz.jpg. Accordingly, the repair documents received should include file123.html, fileabc.html, and graphicxyz.jpg. If a file identified in the link is not found, then the link considered invalid and is marked as such within the repository database. In other embodiments, the parent document may also be marked as invalid. Furthermore, a notification information the provider of invalid documents may be generated.

In some embodiments, invalid hyperlinks within a repair procedure document may be preplaced by a standard hyperlink. In some embodiments, upon determining that a previously functioning link is no longer working, the process may generate a notification (e.g., an error page) notifying the user that the page is missing and steps are being taken to obtain it. Furthermore, a notification information the provider or OEM of invalid link may be generated.

In some embodiments, the automated process may identify documents that were not uploaded successfully. During subsequent executions of the automated process, the automated process may identify the documents that were flagged as deficient. In those instances, the automated process may be configured to process the documents during subsequent executions. In some embodiments, a parameter at the OEM level may be used to control the number of attempts per vehicle and file. For example, a parameter allowing the number of “retries.”

Next, at 420, associations between repair documents and repair information (e.g., as illustrated in FIG. 3A) and save the association results to a database (as illustrated in FIG. 3B) may be determined. For example, results may be saved to repair document repository 450 and/or collision estimate database 460. In some embodiments, the associations saved to OEM document repository 450 and/or collision estimate database 460 along with other information may be used to extract information for use in other aspects of vehicle estimate and repair cycle. For example, at 440, association values, repair documents, including textual files, image files, and/or video files maybe extracted and pushed to a product database 470. For example, product database 470 may be a database associated with a particular tool or product, such as a collision repair estimate tool (as further illustrated in FIGS. 5A-5D).

### Collision Repair Estimating Tool

FIGS. 5A-5D illustrate collision repair estimating tool (e.g., collision repair estimating tool 146 illustrated in FIG. 1) that utilizes categorized repair documents from a variety of OEMs, as described herein during a repair estimating process. For example, FIG. 5A illustrates a job overview 501 generated by the repair estimating tool 146 according to some embodiments of the disclosed technology. Referring to FIG. 5A, the job overview 501 provides information describing the vehicle, the vehicle owner, the vehicle owner's insurance policy, the repair status of the vehicle, any attachments associated with the estimate, and the like. For example vehicle owner information screen 510 may include the vehicle owner's name, address, contact information, and the like. The vehicle information screen 515 may include the year, make, and model of the vehicle, as well as the submodel, color, license plate number, whether the vehicle is drivable, and the like. The insurance information screen 520 may include the policy number, claim number, deductible amounts, contact information for the claim adjuster, and the like. The repair status screen 525 information may include when the vehicle is due into the auto repair shop, when the repair is estimated to be complete, and the like. The attachment information screen 530 may include photos 531 of the vehicle, a summary of the owner's insurance policy, and the like. The collision repair estimating tool 146 also allows a user to download an existing estimate by clicking the “Download” button 512, to begin writing an estimate, by clicking the “Write Estimate” button 514, or to add to existing estimate, by clicking the “Add Existing Estimate” button 516.

FIG. 5B illustrates a primary repair estimate view 503 generated by the collision repair estimating tool 146 according to some embodiments of the disclosed technology. In this view 503, a user has added several lines to the repair estimate representing parts and/or labor associated to a vehicle category requiring repair. This example will focus on the line for “Impact Bar”, indicated at 541, shown as added to the estimate as repair line 543.

FIG. 5C illustrates a repair document view 505 generated by the collision repair estimating tool 146. In this view 505, a user can view OEM service manual in window 551. This example will focus on the repair document for “Front Inner Structure” section of the vehicle, indicated at 542, which is a sub-section of “Front Inner Structure,” as indicated at 540.

FIG. 5D illustrates a navigation of repair documents view 507 generated by the collision repair estimating tool 146. In this view 507, a user can view the OEM service manual in window 561.

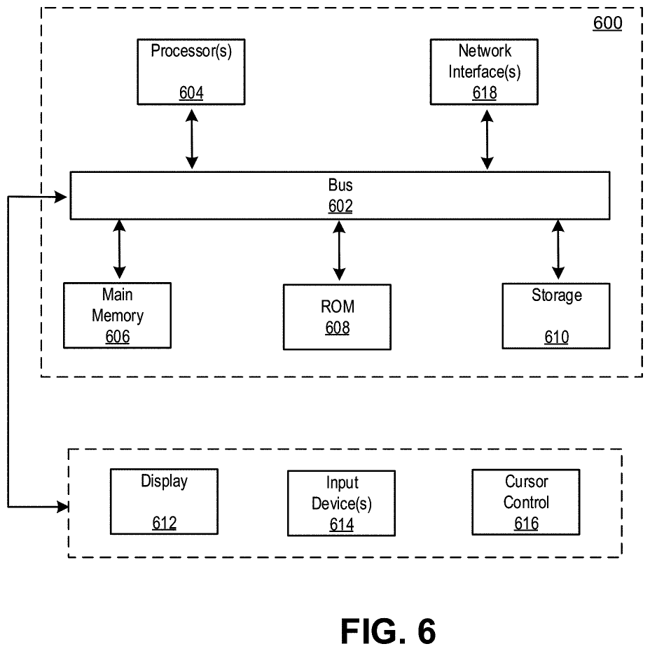

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a transparent heads-up display (HUD) or an optical head-mounted display (OHMD), for displaying information to a computer user. An input device 614, including a microphone, is coupled to bus 602 for communicating information and command selections to processor 604. An output device 616, including a speaker, is coupled to bus 602 for communicating instructions and messages to processor 604.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. Components may also be written in a database language such as SQL and/or handled via a database object such as a trigger or a constraint. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 605. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 605. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire, and fiber optics, including the wires that comprise bus 602. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system, comprising:
a hardware processor; and
a non-transitory machine-readable storage medium encoded with instructions executable by the hardware processor, wherein the hardware processor is configured to:
receive, from a first OEM, a first set of repair documents, each repair document specifying repair instructions generated by the first OEM for repairing one or more parts of a first vehicle;
catalog each repair document from the first set by assigning a standardized naming label form a set of naming labels to each extracted data element from each repair document of the first set in accordance with a plurality of naming rules and a data schema, wherein the cataloged repair documents of the first set are saved in a data repository;
identify the one or more repair documents from the first set received from first OEM corresponding to each individual repair estimate record of a repair estimate document, each repair estimate record representing an estimate for repairing the one or more parts of the first vehicle by using the standardized naming labels for the first OEM name, the one or more repair category, and the first vehicle name, wherein an association record is generated and saved in the data repository for each identified repair document; and
upon receiving a second set of repair documents from the first OEM, automatically catalog updated repair documents in the data repository based on the plurality of naming rules and the data schema used to catalog the first set of repair documents, wherein the updated repair documents of the second set replace the one or more repair document of the first set, and wherein the association records generated for the one or more identified repair documents of the first set are saved with each of the corresponding updated repair documents of the second set;
wherein the set of standardized naming labels comprises a standardized OEM name, a standardized document title, a one or more standardized repair category, and a standardized vehicle name.

2. The system of claim 1, wherein the second set of repair documents identify the first vehicle using a first OEM naming convention, and wherein the repair estimate records of the repair estimate document identify the first vehicle using the standardized naming labels.

3. The system of claim 1, wherein the hardware processor is further configured to: receive, from a second OEM, a third set of OEM repair documents, each repair document specifying repair instructions generated by the second OEM for repairing a second vehicle.

4. The system of claim 3, wherein the hardware processor is further configured to:
automatically catalog each repair document from the third set by applying the plurality of naming rules and the data schema used to catalog the first set of repair documents for the first OEM, wherein the cataloged repair documents of the third set are saved in the data repository; wherein the second set of OEM repair documents identify the third vehicle by using a second OEM naming convention.

5. The system of claim 4, wherein the hardware processor is further configured to:
identify the one or more repair documents from the third set received from second OEM corresponding to individual repair estimate records of a second repair estimate document, each repair estimate record representing an estimate for repairing the one or more parts of the second vehicle by using the standardized naming labels for the second OEM name, the one or more repair category, and the second vehicle name, wherein an association record is generated and saved in the data repository for each of the identified repair document of the third set.

6. (canceled)

7. (canceled)

8. The system of claim 1, wherein each repair document of the first set specifies a repair document provider, a document type, and a file path.

9. The system of claim 3, wherein each repair document of the third set of repair documents specifies a repair document provider, a document type, and a file path.

10. The system of claim 8, wherein the hardware processor is further configured to: update the association record generated in response to identifying a repair document of the first set corresponding to a repair estimate record of the repair estimate document to include the the repair document provider, the document type, and the file path associated with each OEM repair document of the first set.

11. The system of claim 9, wherein the hardware processor is further configured to: update the association record generated in response to identifying a repair document of the third set corresponding to a repair estimate record of the second repair estimate document to include the the repair document provider, the document type, and the file path associated with each OEM repair document of the second set.

12. A non-transitory machine-readable storage medium encoded with instructions executable by a hardware processor of a computing component, the machine-readable storage medium comprising instructions to cause the hardware processor to:
receive, from a first OEM, a first set of repair documents, each repair document specifying repair instructions generated by the first OEM for repairing one or more parts of a first vehicle;
catalog each repair document from the first set by assigning a standardized naming label form a set of naming labels to each extracted data element from each repair document of the first set in accordance with a plurality of naming rules and a data schema, wherein the cataloged repair documents of the first set are saved in a data repository;
identify the one or more repair documents from the first set received from first OEM corresponding to each individual repair estimate record of a repair estimate document, each repair estimate record representing an estimate for repairing the one or more parts of the first vehicle by using the standardized naming labels for the first OEM name, the one or more repair category, and the first vehicle name, wherein an association record is generated and saved in the data repository for each identified repair document; and
upon receiving, a second set of repair documents from the first OEM, automatically catalog updated repair documents in the data repository based on the plurality of naming rules and the data schema used to catalog the first set of repair documents, wherein the updated repair documents of the second set replace the one or more repair document of the first set, and wherein the association records generated for the one or more identified repair documents of the first set are saved with each of the corresponding updated repair documents of the second set;
wherein the set of standardized naming labels comprises a standardized OEM name, a standardized document title, a one or more standardized repair category, and a standardized vehicle name.

13. The non-transitory machine-readable storage medium of claim 12, wherein the second set of repair documents identify the first vehicle using a first OEM naming convention, and wherein the repair estimate records of the repair estimate document identify the first vehicle using the standardized naming labels.

14. The non-transitory machine-readable storage medium of claim 13, comprising wherein the plurality of instructions when executed by the hardware processor further cause the hardware processors to: receive, from a second OEM, a third set of OEM repair documents, each repair document specifying repair instructions generated by the second OEM for repairing a second vehicle.

15. The non-transitory machine-readable storage medium of claim 12, wherein the plurality of instructions when executed by the hardware processor further cause the hardware processors to:
automatically catalog each repair document from the third set by applying the plurality of naming rules and the data schema used to catalog the first set of repair documents for the first OEM, wherein the cataloged repair documents of the third set are saved in the data repository; wherein the second set of OEM repair documents identify the third vehicle by using a second OEM naming convention.

16. The non-transitory machine-readable storage medium of claim 13, wherein the plurality of instructions when executed by the hardware processor further cause the hardware processors to:
identify the one or more repair documents from the third set received from second OEM corresponding to individual repair estimate records of a second repair estimate document, each repair estimate record representing an estimate for repairing the one or more parts of the second vehicle by using the standardized naming labels for the second OEM name, the one or more repair category, and the second vehicle name, wherein an association record is generated and saved in the data repository for each of the identified repair document of the third set.

17. The non-transitory machine-readable storage medium of claim 12, wherein each repair document of the first set specifies a repair document provider, a document type, and a file path.

18. The non-transitory machine-readable storage medium of claim 13, wherein each repair document of the third set of repair documents specifies a repair document provider, a document type, and a file path.

19. The non-transitory machine-readable storage medium of claim 13, wherein the plurality of instructions when executed by the hardware processor further cause the hardware processors to:
update the association record generated in response to identifying a repair document of the first set corresponding to a repair estimate record of the repair estimate document to include the the repair document provider, the document type, and the file path associated with each OEM repair document of the first set.

20. The non-transitory machine-readable storage medium of claim 19, wherein the plurality of instructions when executed by the hardware processor further cause the hardware processors to:
update the association record generated in response to identifying a repair document of the third set corresponding to a repair estimate record of the second repair estimate document to include the the repair document provider, the document type, and the file path associated with each OEM repair document of the second set.

21. A method implemented by a server computer, the method comprising:
receiving, from a data repository, a set of OEM repair documents, each OEM repair document specifying OEM repair instructions generated by an OEM for repairing an OEM vehicle; determining a service repair vehicle corresponding to the OEM vehicle;
cataloging each repair document from the first set by assigning a standardized naming label form a set of naming labels to each extracted data element from each repair document of the first set in accordance with a plurality of naming rules and a data schema, wherein the cataloged repair documents of the first set are saved in a data repository;
identifying the one or more repair documents from the first set received from first OEM corresponding to each individual repair estimate record of a repair estimate document, each repair estimate record representing an estimate for repairing the one or more parts of the first vehicle by using the standardized naming labels for the first OEM name, the one or more repair category, and the first vehicle name, wherein an association record is generated and saved in the data repository for each identified repair document; and
upon receiving a second set of repair documents from the first OEM, automatically cataloging updated repair documents in the data repository based on the plurality of naming rules and the data schema used to catalog the first set of repair documents, wherein the updated repair documents of the second set replace the one or more repair document of the first set, and wherein the association records generated for the one or more identified repair documents of the first set are saved with each of the corresponding updated repair documents of the second set;
wherein the set of standardized naming labels comprises a standardized OEM name, a standardized document title, a one or more standardized repair category, and a standardized vehicle name.

22. A method of claim 21, further comprising:
receiving, from a second OEM, a third set of OEM repair documents, each repair document specifying repair instructions generated by the second OEM for repairing a second vehicle; and
automatically cataloging each repair document from the third set by applying the plurality of naming rules and the data schema used to catalog the first set of repair documents for the first OEM, wherein the cataloged repair documents of the third set are saved in the data repository;
wherein the second set of OEM repair documents identify the third vehicle by using a second OEM naming convention.
